(19) United States
(12) Patent Application Publication
(10) Pub. No.: US 2019/0122323 A1
(43) Pub. Date: Apr. 25, 2019

(54) SYSTEMS AND METHODS FOR DYNAMIC ALLOCATION

(71) Applicant: Walmart Apollo, LLC, Bentonville, AR (US)

(72) Inventor: Andrew B. Millhouse, Gilbert, AZ (US)

(21) Appl. No.: 16/165,103

(22) Filed: Oct. 19, 2018

Related U.S. Application Data
(60) Provisional application No. 62/574,470, filed on Oct. 19, 2017.

(51) Int. Cl. G06Q 50/28; G06F 17/30; G06Q 10/06

(52) U.S. Cl. CPC G06Q 50/28; G06Q 10/06311; G06F 17/30876

(57) ABSTRACT

A dynamic allocation system is discussed that includes an allocation engine executable on a computing device that retrieves tasks for moving objects during a predefined time period. The allocation engine assigns a first set of tasks for moving a first set of objects to a group of individuals based on a first set of predefined parameters. The allocation engine assigns, following completion of the first set of tasks, a second set of tasks for moving a second set of objects to the group of individuals based on a second set of predefined parameters.

### CROSS-REFERENCE TO RELATED PATENT APPLICATIONS

This application claims priority to U.S. Provisional Application No. 62/574,470, filed on Oct. 19, 2017, the content of which is hereby incorporated by reference in its entirety.

### BACKGROUND

Individuals in a facility routinely perform tasks within the facility for various reasons, such as stocking and retrieving items. Task processes ensure that a certain number of items are processed per hour per individual in the facility, thereby improving the facility's capacity to unload deliveries, fulfill online orders, and drive operational costs down.

### BRIEF DESCRIPTION OF DRAWINGS

To assist those of skill in the art in making and using a dynamic allocation system and associated methods, reference is made to the accompanying figures. The accompanying figures, which are incorporated in and constitute a part of this specification, illustrate one or more embodiments of the present invention and, together with the description, help to explain the present disclosure. Illustrative embodiments are shown by way of example in the accompanying drawings and should not be considered as limiting. In the figures:

FIG. 1 illustrates an exemplary network for a dynamic allocation system, in accordance with an exemplary embodiment;

FIG. 2 illustrates a method of dynamically assigning a task to an individual, according to an exemplary embodiment;

FIG. 3 illustrates a method of dynamically assigning a task using artificial intelligence, according to an embodiment;

FIG. 4 illustrates another method for dynamically assigning a task to an individual, according to an exemplary embodiment;

FIG. 5 is an exemplary illustration of evaluating parameters, in accordance with an exemplary embodiment; and

FIG. 6 is a block diagram of an exemplary computing device suitable for use in an exemplary embodiment.

### DETAILED DESCRIPTION

Described in detail herein is a dynamic allocation system for assigning tasks to individuals within a facility.

In one illustrative embodiment, a system includes sensors each configured to determine a walking distance and/or identify a location of an associated individual, such as an employee, within the facility. The system further includes one or more task allocation databases storing information regarding unassigned tasks to be performed within the facility and information regarding previous performance of past tasks by each individual. For example, the unassigned tasks and past tasks may be related to a movement of objects within the facility. The system also includes an allocation engine executable on a computing device equipped with a processor. The allocation engine retrieves, from the one or more task allocation databases, tasks for moving objects during a predefined time period. Each task includes identifies at least a weight of an object and a start location and an end location for moving the object. The allocation engine assigns a first set of tasks for moving a first set of objects to individuals in a facility based on a first set of predefined parameters. The first set of predefined parameters includes at least a weight of each object and a walking distance to move each object between the start location and the end location.

The allocation engine assigns, following completion of the first set of tasks, a second set of tasks for moving a second set of objects to the individuals who completed the first set of tasks based on a second set of predefined parameters. The second set of predefined parameters includes at least the walking distance traveled and a weight carried for each individual while completing the first set of tasks, a weight of each object in the second set of objects, and a walking distance to move each object in the second set of objects between the start location and the end location. In some embodiments, the walking distance traveled is determined by a sensor associated with an individual performing a task of the set of tasks. For example, the sensor may be a badge that includes a beacon attached to the individual or located within a mobile computing device carried by the individual. In another embodiment, the walking distance traveled is determined by one or more sensors disposed within the facility and configured to detect and determine distance traveled by an individual.

In an exemplary embodiment of the system, the allocation engine transmits the assigned tasks to one or more user interfaces viewable by the individuals being assigned the tasks. For example, the assigned task may be transmitted to a central display viewable the individuals or may be transmitted to a personal device of the individual such as, but not limited to, the individual's smartphone.

In one embodiment, the allocation engine assigns a set of tasks to individuals based on a set of predefined parameters by determining a minimum preferred value and a maximum preferred value for a first predefined parameter (e.g., weight, distance, etc.) of the set of predefined parameters. In one embodiment, the system includes an artificial intelligence (AI) engine. The AI engine determines the minimum preferred values and the maximum preferred values for each predefined parameter using artificial intelligence based on a difference between an average value of the predefined parameter for all individuals in a group of individuals and an average value of the predefined parameter for the individual being assigned a task, and a weight percentage. The weight percentage is a weight value given to a parameter. For each predefined parameter, the AI engine analyzes an impact of changes previously made to a task assignment, performs adjustments, and attempts to improve on a key performance indictor (KPI). In some cases, the KPI is cases-shipped-per-hour, a metric that may be important to track in a distribution center or loading dock facility. In an alternative embodiment, the minimum preferred values and the maximum preferred values are determined using mathematical algorithms based on the average value of the predefined parameter for all individuals in the group of individuals and the average value of the predefined parameter for the individual being assigned a task, and the weight percentages. For example, in one embodiment, the maximum preferred value is determined using the following calculation: (average value for all individuals+average value for the individual being assigned a task+(average value for all individuals+average value for the individual being assigned a task)*weight percentage), and the minimum preferred value is determined using the following calculation: (average value for all individuals+average value for the individual being assigned a task−((average value for all individuals+average value for the individual being assigned a task)*weight percentage).

The minimum preferred value and the maximum preferred value of the first predefined parameter provides a range. A task with a parameter value that falls within the range is a candidate task for possible assignment to the individual. The parameter value is a value associated with the task for the given predefined parameter. For example, if the predefined parameter is a weight parameter then the value is an amount of weight carried during the task. If there is more than one candidate task that can be assigned to the individual, the allocation engine proceeds with a second predefined parameter. The allocation engine determines a range for the second predefined parameter, and, using the candidate tasks determined based on the first predefined parameter, determines which candidate tasks have parameter values falling within the range for the second predefined parameter. If there is still more than one candidate task that can be assigned to the individual, the allocation engine proceeds with a third predefined parameter, and so forth.

For example, a task allocation database includes a first set of three tasks with a set of four predefined parameters, as shown in Table 1. The set of predefined parameters are assigned a priority that determines an order that the parameters are utilized reflective of the relative importance of the particular parameter for the task. In one embodiment, as explained in greater detail further herein the parameters are utilized from a most important parameter to a least important as necessary to assign a task. The set of predefined parameters shown in Table 1 are a weight parameter, a temperature parameter, a height parameter, and a distance parameter. The weight parameter includes a parameter value for each task associated with a total weight an individual will carry during the task (for example, 276 lbs. during task 1). The temperature parameter includes a parameter value for each task determined based on an amount of time an individual will spend in each temperature zones during the task (for example, a sum of (temperature zone 1*percentage of time spent in temperature zone 1, temperature zone 2*percentage of time spent in temperature zone 2, . . . )). The height parameter includes a parameter value for each task associated with a total height the individual will climb during the task (for example, 188 inches during task 1). The distance parameter includes a parameter value for each task associated with a total distance the individual will travel during the task (for example, 145 feet during task 1). It should be appreciated that the particular parameters discussed herein are discussed for purposes of explanation and that the parameters of interest for a particular task may, and often will, vary from those discussed herein.

TABLE 1

| | Weight | Temperature | Height | Distance |
|---|---|---|---|---|
| Task 1 | 276 | 34 | 188 | 145 |
| Task 2 | 220 | 37 | 108 | 124 |
| Task 3 | 117 | 43 | 213 | 175 |
| | | Area | Height | |
| | Weight | temperature | climbed | Distance |
| Priority | lifted | (coldness) | (elevated slots) | walked |
| 1-4 (Left | 15% | 25% | 50% | 15% |
| to Right) | | | | |

For example, an exemplary Worker One has the attributes shown in Table 2. The attributes shown in Table 2 are a weight attribute, a temperature attribute, a height attribute, and a distance attribute. The weight attribute is an average weight carried by the particular individual/worker during tasks performed over a predefined time period (e.g., a shift, the past week, the past month, etc.). The temperature attribute is an average temperature the individual is exposed to while performing tasks during the predefined time period. The height attribute is an average height climbed by the individual while performing tasks during the predefined time period. The distance attribute is an average distance covered by the individual while performing tasks during the predefined time period.

TABLE 2

| | | | Average | Average |
|---|---|---|---|---|
| | Average | Average | Height | Distance |
| | Weight | Temperature | Climbed | Walked |
| | per Task | per Task | per Task | per Task |
| Worker 1 | 154 | 49 | 111 | 177 |

In an exemplary embodiment, as an initial step, the allocation engine analyzes the first set of tasks based on the weight parameter, as shown in Table 3. The allocation engine determines a difference between an average weight carried for all individuals in a facility on a single trip and the weight attribute for Worker One, reflecting the average weight carried by Worker One per trip. A minimum preferred weight and a maximum preferred weight is determined as described above. The minimum preferred weight and the maximum preferred weight provides a range of acceptable parameter values for the allocation engine when performing task assignment. As shown in Table 3, the allocation engine determines that task 1 is the only task with a parameter value within the range. Since task 1 is the only candidate task, the allocation engine assigns task 1 to Worker One.

In one embodiment, the allocation engine performs task allocation sequentially for the group of available individuals. That is, if there were more than one candidate task that was able to be assigned to the individual from the first set of retrieved tasks (e.g. had parameter values within the designated range), the allocation engine would proceed with the next predefined parameter (temperature) and analyze the candidate tasks based on the next predefined parameter. The allocation engine would continue analyzing predefined parameters and filtering the candidate tasks until there is only one candidate task for assignment to that particular worker. Once the candidate task is assigned, the candidate task is removed from the first set of tasks and the allocation engine proceeds to the next available individual and assigning the remaining unassigned tasks from the first set of retrieved tasks. In one embodiment, the number of tasks in the first set of retrieved tasks and the number of available workers will have a one-to-one correspondence. In another embodiment, more than one task can be assigned to the same individual. The above analysis is performed for each individual until all the tasks within the first set of tasks have been assigned. The allocation engine then retrieves a second set of tasks from the task allocation database and repeats the process described above. The second set of tasks may include the same set of predefined parameters, a novel set of predefined parameters, or a mix of the two.

Although described in the examples herein as a sequential allocation where the set of tasks is analyzed and one (or more) of the tasks are assigned to a single individual before the remaining individuals are examined, it should be appreciated that in another embodiment the analysis described above can be performed for all of the tasks and all of the available individuals to determine the most appropriate assignment of candidate tasks. A tiebreaker mechanism may be provided in the event more than one individual has more than one possible candidate task available for assignment. For example, a task eligible to be assigned to two or more individuals may be assigned by the allocation engine by determining for which individual the task parameter value is closest to the middle of the minimum/maximum parameter range. It will be appreciated that other tiebreaking allocation mechanisms may also be provided without departing from the scope of the present invention.

The dynamic allocation system described herein increases a speed and an efficiency of dynamically assigning tasks using a technical solution based on predefined parameters and changing employee attributes. The dynamic allocation system improves productivity by assigning tasks with greater uniformity and prevents an uneven distribution of work that leads to reduced productivity for the overworked individuals. For example, the system uses a technical solution to prevent some individuals from carrying more weight, walking greater distances, etc., than other workers.

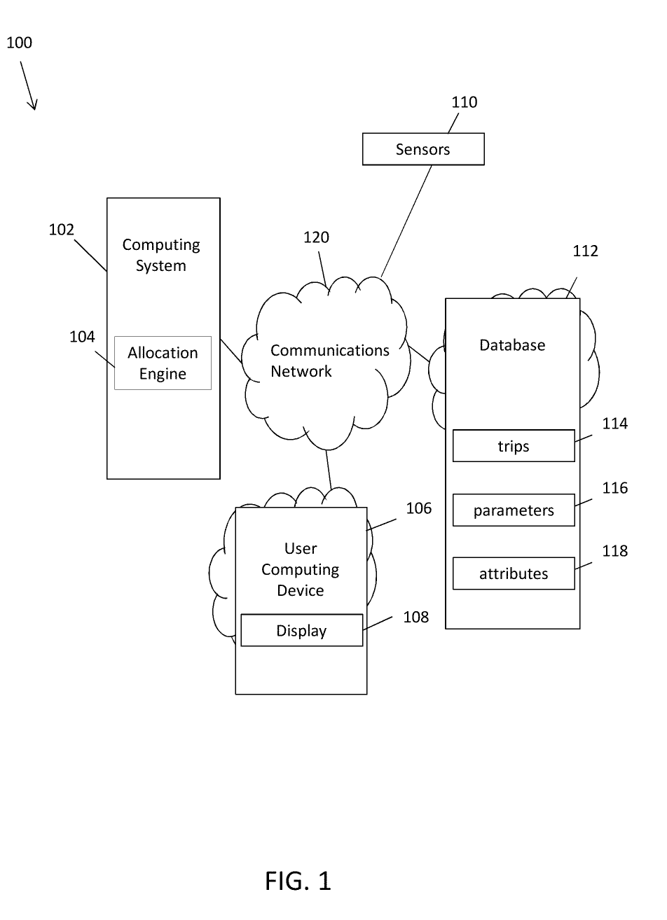

FIG. 1 illustrates an exemplary network 100 for a dynamic allocation system 100. The network 100 includes a computing device 102 equipped with a processor configured to execute an allocation engine 104. It will be appreciated that the allocation engine may be provided as a series of executable software and/or firmware instructions. The computing device 102 communicates, via a communications network 120, with one or more user computing devices 106 located within a facility. The user computing device 106 includes a display 108 for displaying assigned tasks to individuals. The user computing device 106 may be a smartphone, tablet, laptop, workstation or some other type of electronic device equipped with a processor and able to communicate with computing device 102. User computing device 106 may or may not be a mobile device. Computing device 102 may also communicate with a central display (not shown) viewable by individuals in the facility.

In one embodiment, the computing system 102 may transmit assigned tasks, via a webpage and/or an application on the user computing device 106, to the display 108 or central display. A task may include, for example: traveling from a current location to a first pick location or multiple pick locations to retrieve and/or stock items; performing a search required for an identification of an item; retrieving or stocking items; moving items from a corresponding article location onto a tote; set-up tasks; collecting trolleys/carts, and setting up of devices and printers. During a task, an individual may perform activities that include lifting, walking, moving, picking, storing, packing, and the like.

The dynamic allocation system 100 includes one or more sensors 110 each configured to identify a location of an individual associated with the sensor 110. For example, in one embodiment, each employee may wear a badge that includes a beacon or other type of sensor 110 configured to broadcast a signal containing data. For example, in one embodiment, the sensor 110 is configured to transmit data signals using a radio frequency.

The dynamic allocation system 100 further includes a location for data storage 112, such as but not limited to a database. Data storage 112 includes, but is not limited to, storing information regarding unassigned and/or previously performed tasks 114, predefined parameters 116 and associated values, and worker attributes 118. Unassigned tasks 114 are typically for a predefined time period (e.g., unassigned tasks includes tasks to be assigned on a daily basis, hourly basis, etc.). Although data storage 112 is shown as remote from computing system 102, in alternative embodiments, data storage 112 can exist within user computing system 102.

The communications network 120 can be any network over which information can be transmitted between devices communicatively coupled to the network. For example, the communication network 120 can be the Internet, an Intranet, virtual private network (VPN), wide area network (WAN), local area network (LAN), and the like.

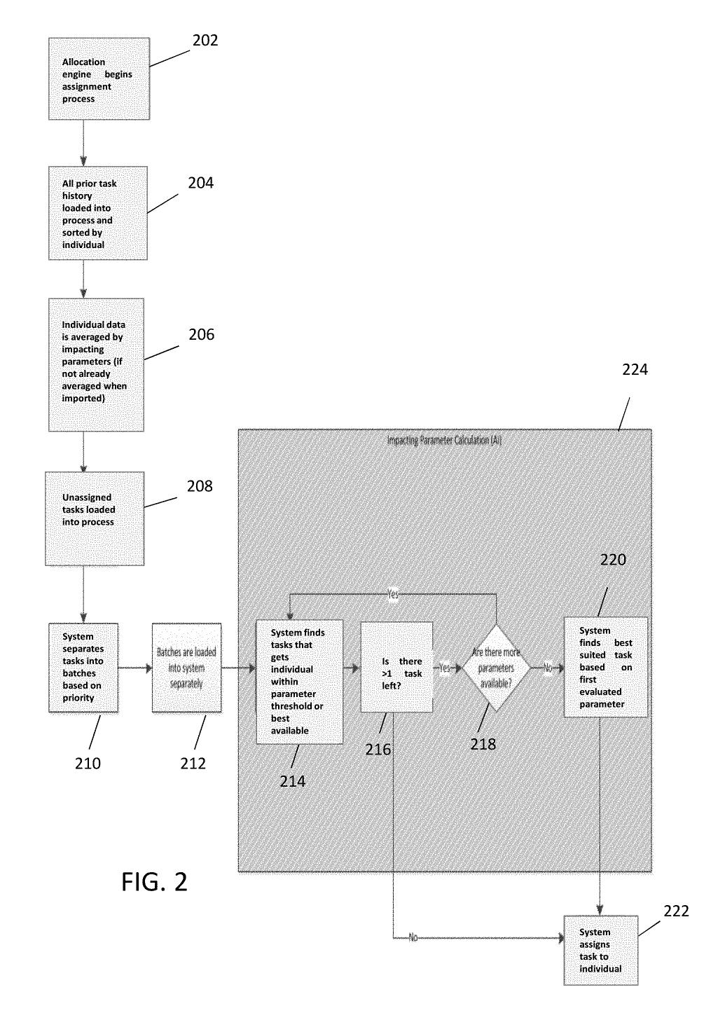

FIG. 2 illustrates a method of assigning a task to an individual, according to an exemplary embodiment. At step 202, an allocation engine begins the task assignment process. At step 204, prior task histories are loaded and sorted by individual. At step 206, individual attributes are obtained from a data storage and, if not already averaged when imported, averaged by predefined parameters over a predefined time period (e.g., an average weight carried by the individual over a past month) by the allocation engine. At step 208, unassigned tasks are obtained from the data storage and loaded into the allocation engine. In some embodiments, at step 210, the allocation engine separates tasks into sets or batches based on priority (e.g., sets of tasks separated based on high, medium, and low priority) and groups the tasks into sets of tasks equal in number to the number of available individuals in the facility for performing the tasks. At step 212, a first set of tasks is loaded into the allocation engine separately, beginning with the high priority set.

At step 214, the allocation engine determines candidate tasks for an individual that are within a range determined for a first predefined parameter, as described above. At step 216, the allocation engine determines whether there are more than one candidate task for the individual. If there is more than one candidate task, at step 218, the allocation engine determines whether there are additional predefined parameters available. If there are additional parameters available, the allocation engine returns to step 214 and repeat the process with the next predefined parameter. If there are no additional predefined parameters available, at step 220, the allocation engine determines a task that is closest to being within the range of the first predefined parameter. At step 222, the allocation engine assigns the task to the individual.

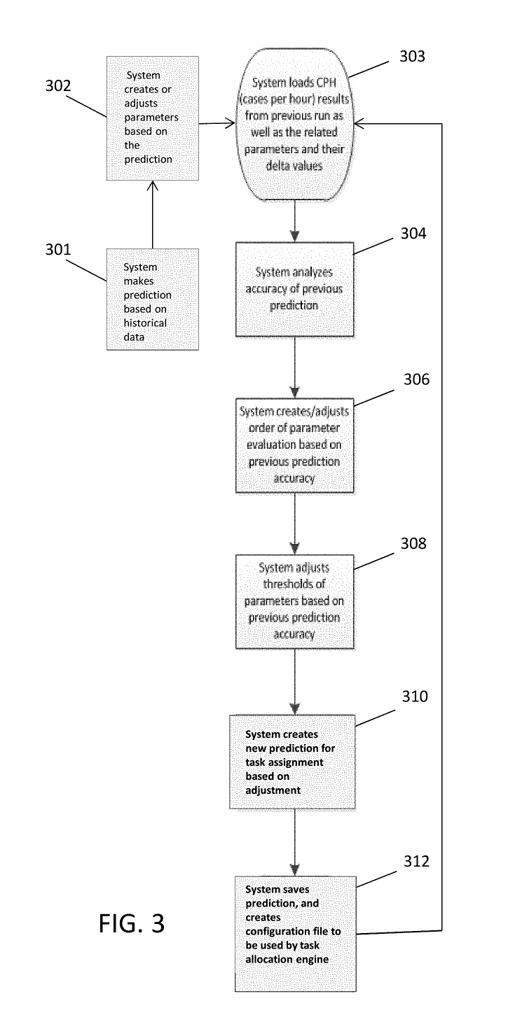

At step 216, if there is only one candidate task, the allocation engine proceeds to step 222 and assigns the task to the individual. In one embodiment, the shaded area 224 represents the steps (214-220) impacted by incorporating artificial intelligence into the allocation process, as described in FIG. 3.

FIG. 3 illustrates a method of assigning a task using artificial intelligence, according to an embodiment. At step 301, in an exemplary embodiment, a prediction associated with a set of unassigned tasks is generated by an AI engine. The AI engine uses historical data for the prediction. For example, in one embodiment, the AI engine creates the prediction for the set of unassigned tasks based on past assignments, a current priority order of predefined parameters, and/or current ranges. The prediction may be, for example, how many cases will be moved per hour. The prediction may be that 300 cases will be moved per hour based on the current priority order of the predefined parameters and current ranges.

At step 302, the AI engine creates or adjusts an order of evaluating the predefined parameters and/or ranges for one or more predefined parameters based on the prediction. For example, the AI engine may determine that a different order of evaluating the predefined parameters may result in a more accurate prediction.

At step 303, the AI engine loads a result from a set of completed tasks (for example, a number of cases moved per hour from a previous set of tasks) as well as the related predefined parameters, delta values, and ranges. A delta value is a difference between an average value of a predefined parameter for all individuals and an average value of the predefined parameter for an individual being assigned a task.

At step 304, the AI engine analyzes an accuracy of the prediction. For example, the AI engine analyzes an impact of changes to the parameters and compares that to the average deviation of the cases moved per hour (e.g., a key performance indicator).

At step 306, the AI engine creates or adjusts an order of evaluating the predefined parameters based on the prediction accuracy. At step 308, the AI engine adjusts the ranges for one or more predefined parameters based on the prediction accuracy. For instance, the AI engine may increase an accuracy of an average weight per task calculation or decrease an accuracy of the average weight per task calculation.

At step 310, the AI engine creates a new prediction for task assignments based on the adjustments. For example, the prediction may be that 400 cases will now be moved based on an adjusted priority order of parameters and adjusted parameter ranges. At step 312, the prediction is saved, and the AI engine creates a configuration file with the adjusted priority order and/or adjusted parameter ranges to be used by the allocation engine.

The system then returns to step 303 to load results from a next set of completed tasks, analyze prediction accuracy, and adjust parameters. For instance, the AI engine may determine that the increase to the accuracy of an average weight per task calculation had a negative impact (greater than the average deviation under cases per hour) on the prediction accuracy, and the AI engine may reverse this change and potentially decrease an accuracy of the average weight per task calculation. Conversely, if the analysis showed that the increase to the accuracy of an average weight per task calculation had a positive impact (greater than the average deviation over cases per hour) on the prediction accuracy, the AI engine may further increase the accuracy of the average weight per task calculation to determine whether further prediction accuracy could be gained.

In an exemplary embodiment, the AI engine is consistently adjusting the parameter order and ranges after every set of completed tasks in order to increase prediction accuracy. The AI engine may also store the calculations for future use. With seasonal changes, the system may revert to previous year configurations if the AI engine identified seasonal deviations.

In alternative embodiments, at step 301, the prediction associated with the set of unassigned tasks is determined and inputted by an individual.

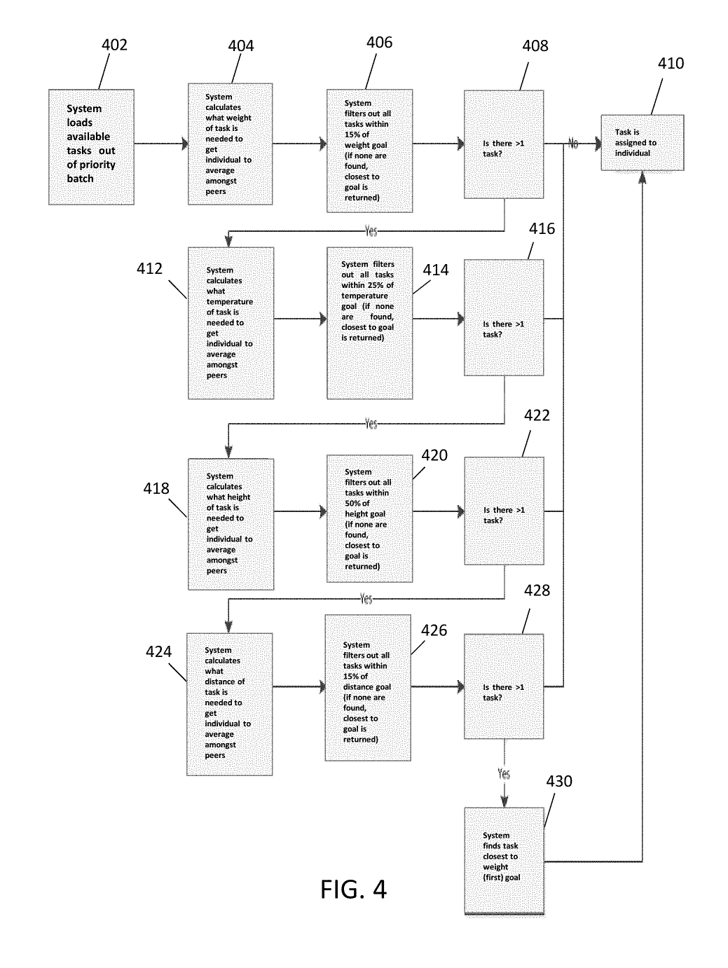

FIG. 4 is a method for assigning a task to an individual, according to another exemplary embodiment. In step 402, the allocation engine imports unassigned tasks from a database. In the exemplary embodiment, the tasks are loaded by set based on priority, with the highest priority set loaded first. As shown, the set of predefined parameters are a weight parameter, a temperature parameter, a height parameter, and a distance parameter. The method is based on a weight percentage of weight lifted—15%, area temperature—25%, height climbed—50%, and distance walked—15%.

In step 404, the allocation engine begins with a weight parameter by calculating a weight goal needed to get an individual being assigned a task to an average weight for all individuals. In step 406, the allocation engine filters out all tasks within 15% of the weight goal (if no tasks are found, a task closest to the weight goal is returned). In step 408, the allocation engine determines whether there is only one candidate task filtered out during step 406. If there is only one candidate task, at step 410, the allocation engine assigns the candidate task to the individual.

If there is more than one candidate task, at step 412, the allocation engine calculates a temperature goal needed to get the individual being assigned a task to an average temperature for all individuals. In step 414, the allocation engine filters out all tasks within 25% of the temperature goal (if no tasks are found, a task closest to the temperature goal is returned). In step 416, the allocation engine determines whether there is only one candidate task filtered out during step 414. If there is only one candidate task, at step 410, the allocation engine assigns the candidate task to the individual.

If there is still more than one candidate task, at step 418, the allocation engine calculates a height goal needed to get the individual being assigned a task to an average height for all individuals. In step 420, the allocation engine filters out all tasks within 50% of the height goal (if no tasks are found, a task closest to the height goal is returned). In step 422, the allocation engine determines whether there is only one candidate task filtered out during step 420. If there is only one candidate task, at step 410, the allocation engine assigns the candidate task to the individual.

If there is still more than one candidate task, at step 424, the allocation engine calculates a distance goal needed to get the individual being assigned a task to an average distance for all individuals. In step 426, the allocation engine filters out all tasks within 15% of the distance goal (if no tasks are found, a task closest to the distance goal is returned). In step 428, the allocation engine determines whether there is only one candidate task filtered out during step 426. If there is only one candidate task, at step 410, the allocation engine assigns the candidate task to the individual.

If there is still more than one candidate task, at step 430, the allocation engine determines a task closest to the weight goal. At step 410, the task is assigned to the individual.

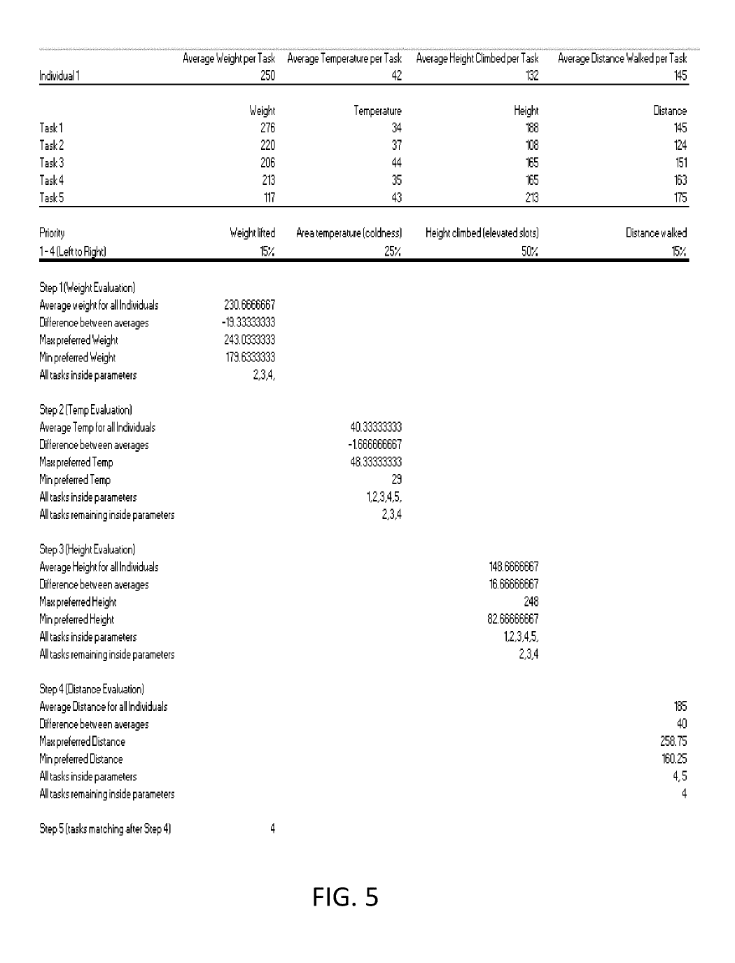

FIG. 5 is an exemplary illustration of evaluating the parameters, in accordance with an exemplary embodiment.

In another embodiment, the tasks may include a time parameter that tracks the amount of time spent in temperature zones by the individuals performing the tasks. Using the principals described above, the allocation engine analyzes the amount of time spent in temperature zones by each individual while performing their assigned tasks and assigns future tasks so as to even out the allocation of this parameter among workers. In one embodiment, this may be performed by the allocation engine leveraging location information received from sensors affixed to and/or tracking the location of the individuals while performing their tasks in the various temperature zones in a facility.

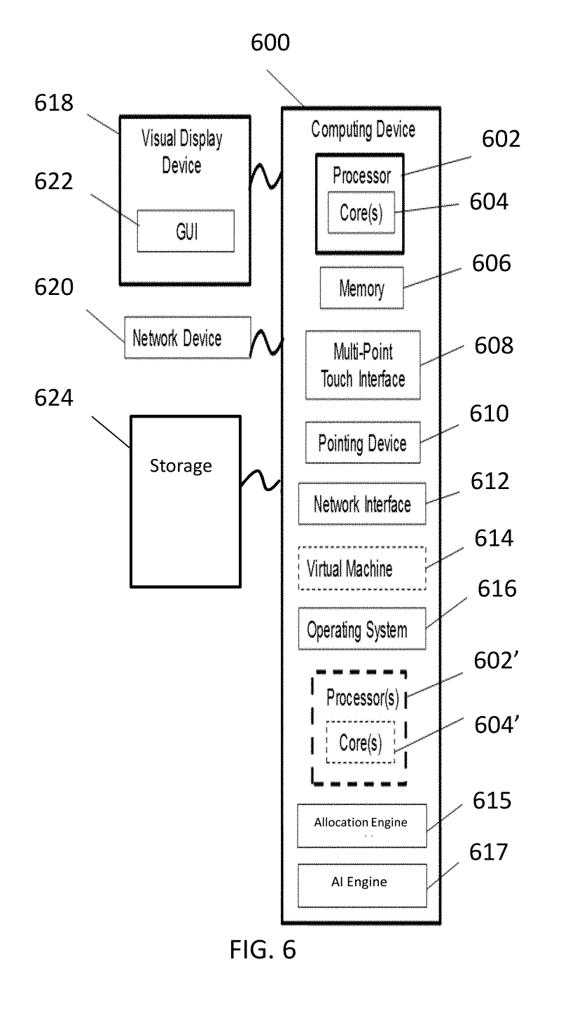

FIG. 6 is a block diagram of an example computing device 600 that can be used to perform one or more steps provided by exemplary embodiments. In an exemplary embodiment, computing device 600 is a computing device 102 shown in FIG. 1 and/or user computing device 106 shown in FIG. 1. Computing device 600 includes one or more non-transitory computer-readable media for storing one or more computer-executable instructions or software for implementing exemplary embodiments such as the prioritization module described herein. The non-transitory computer-readable media can include, but are not limited to, one or more types of hardware memory, non-transitory tangible media (for example, one or more magnetic storage disks, one or more optical disks, one or more USB flash drives), and the like. For example, a memory 606 included in computing device 600 can store computer-readable and computer-executable instructions or software for implementing exemplary embodiments such as the prioritization module described herein. Computing device 600 also includes a processor 602 and an associated core 604, and optionally, one or more additional processor(s) 602′ and associated core(s) 604′ (for example, in the case of computer systems having multiple processors/cores), for executing computer-readable and computer-executable instructions or software stored in memory 606 and other programs for controlling system hardware. Processor 602 and processor(s) 602′ can each be a single core processor or multiple core (604 and 604′) processor. Computing device 600 may further include an allocation engine 615 and an AI engine 617.

Virtualization can be employed in computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can include a computer system memory or random access memory, such as DRAM, SRAM, EDO RAM, and the like. Memory 606 can include other types of memory as well, or combinations thereof. In some embodiments, a customer can interact with computing device 600 through a visual display device 618, such as a touch screen display or computer monitor, which can display one or more customer interfaces 619 that can be provided in accordance with exemplary embodiments. Visual display device 618 may also display other aspects, elements and/or information or data associated with exemplary embodiments. Computing device 600 may include other I/O devices for receiving input from a customer, for example, a keyboard or any suitable multi-point touch interface 608, a pointing device 610 (e.g., a pen, stylus, mouse, or trackpad). The keyboard 608 and pointing device 610 may be coupled to visual display device 618. Computing device 600 may include other suitable conventional I/O peripherals.

Computing device 600 can also include one or more storage devices 624, such as a hard-drive, CD-ROM, or other computer readable media, for storing data and computer-readable instructions and/or software. Exemplary storage device 624 can also store one or more storage devices for storing any suitable information required to implement exemplary embodiments. In an exemplary embodiment, the storage device 624 stores tasks, predefined parameters, and individual attributes.

Computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing computing device 600 to any type of network capable of communication and performing the operations described herein. Moreover, computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

Computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances.

The description herein is presented to enable any person skilled in the art to create and use a computer system configuration and related method and systems for dynamically allocating tasks to individuals. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. A dynamic allocation system, comprising:
one or more databases holding information regarding tasks to be performed for a plurality of objects in a facility and information regarding previous performance of past tasks by an associated individual, each associated individual one of a plurality of individuals associated with the facility, the tasks, and past tasks related to movement of objects in the facility;
a plurality of sensors, wherein each sensor is configured to determine a walking distance;
an allocation engine executable on a computing device equipped with a processor, the allocation engine when executed:
retrieving, from the one or more databases, a plurality of tasks for moving objects during a predefined time period, each task identifying at least a weight of an object and a start location and an end location for moving the object;
assigning a first set of tasks for moving a first set of objects to the plurality of individuals based on a first set of predefined parameters, the first set of predefined parameters including at least a weight of each object and a walking distance to move each object between the start location and the end location;
assigning to the plurality of individuals, following completion of the first set of tasks, a second set of tasks from the retrieved plurality of tasks, the second set of tasks for moving a second set of objects and based on a second set of predefined parameters, the second set of predefined parameters including at least the walking distance traveled as determined by a sensor of the plurality of sensors and a weight carried for each of the plurality of individuals while completing the first set of tasks, a weight of each object in the second set of objects, and a walking distance to move each object in the second set of objects between the start location and the end location.

2. The system of claim 1, wherein the allocation engine when executed further:
assigns a third set of tasks for moving a third set of objects to the plurality of individuals based on a third set of predefined parameters, the third set of predefined parameters including at least a walking distance traveled and a weight carried for each associated individual while completing the first set and the second set of tasks, a weight of each object in the third set of objects, and a walking distance to move each object in the third set of objects between the start location and the end location.

3. The system of claim 1, wherein at least one of the first and second set of predefined parameters further include one or more of the following: travel time while performing a task, time since a previous task and height of a climb to retrieve or place an object.

4. The system of claim 1, further comprising a mobile computing device configured to display one or more tasks for an individual associated with the mobile computing device.

5. The system of claim 1, wherein at least one of the first and second set of predefined parameters includes one or more temperature zones.

6. The system of claim 5, further comprising:
each sensor of the plurality of sensors further configured to identify a location of an associated individual, wherein at least one of the first and second set of predefined parameters includes a time spent by an associated individual in the one or more temperature zones, the time determined using location information received from one of the plurality of sensors to establish a presence of the associated individual in the one or more temperature zones.

7. The system of claim 1, wherein the allocation engine when executed further:
receives and stores in the one or more databases histories for the plurality of individuals, the histories including at least weights of objects previously moved by each individual of the plurality of individuals and walking distances traveled by each individual of the plurality of individuals for a predefined period,
wherein the histories are used in determining at least one of the first and second sets of predefined parameters.

8. The system of claim 1, further comprising:
a machine learning module that when executed by the computing device tests at least one predefined parameter in the first and second sets of predefined parameters to identify one or more optimal parameters for one or more tasks, wherein one or more optimal parameters are used to assign tasks.

9. A computer-implemented method for performing dynamic allocation, comprising:
storing in one or more databases information regarding tasks to be performed for a plurality of objects in a facility and information regarding previous performance of past tasks by an associated individual, each associated individual one of a plurality of individuals associated with the facility, the tasks and past tasks related to movement of objects in the facility;
retrieving, from the one or more databases by an allocation engine executable on a computing device equipped with a processor, a plurality of tasks for moving objects during a predefined time period, each task identifying at least a weight of an object and a start location and an end location for moving the object;
assigning, by the allocation engine, a first set of tasks for moving a first set of objects to the plurality of individuals based on a first set of predefined parameters, the first set of predefined parameters including at least a weight of each object and a walking distance to move each object between the start location and the end location; and
assigning to the plurality of individuals, by the allocation engine, following completion of the first set of tasks, a second set of tasks from the retrieved plurality of tasks, the second set of tasks for moving a second set of objects based on a second set of predefined parameters, the second set of predefined parameters including at least the walking distance traveled as determined by a sensor and a weight carried for each of the plurality of individuals while completing the first set of tasks, a weight of each object in the second set of objects, and a walking distance to move each object in the second set of objects between the start location and the end location.

10. The method of claim 9, further comprising:
assigning, by the allocation engine, a third set of tasks for moving a third set of objects to the plurality of individuals based on a third set of predefined parameters, the third set of predefined parameters including at least a walking distance traveled and a weight carried for each associated individual while completing the first set and the second set of tasks, a weight of each object in the third set of objects, and a walking distance to move each object in the third set of objects between the start location and the end location.

11. The method of claim 9, wherein at least one of the first and second set of predefined parameters further include one or more of the following: travel time while performing a task, time since a previous task and height of a climb to retrieve or place an object.

12. The method of claim 9, wherein at least one of the first and second set of predefined parameters includes one or more temperature zones.

13. The method of claim 12, wherein at least one of the first and second set of predefined parameters includes a time spent by an associated individual in the one or more temperature zones, the time determined using location information received from a sensor associated with the associated individual to establish a presence of the associated individual in the one or more temperature zones.

14. The method of claim 9, further comprising:
receiving and storing, by the allocation engine, in the one or more databases histories for the plurality of individuals, the histories including at least weights of objects previously moved by each individual of the plurality of individual and walking distances traveled by each individual of the plurality of individuals for a predefined period,
wherein the histories are used in determining at least one of the first and second sets of predefined parameters.

15. The method of claim 9, further comprising:
testing, by a machine learning module executed by the computing device, at least one predefined parameter in the first and second sets of predefined parameters to identify one or more optimal parameters for one or more tasks, wherein one or more optimal parameters are used to assign tasks.

16. A dynamic allocation system, comprising:
a plurality of sensors each configured to identify a location of an associated individual, each associated individual one of a plurality of individuals associated with a facility;
one or more databases holding information regarding tasks to be performed for a plurality of objects in the facility and information regarding previous performance of past tasks by an associated individual, the tasks and past tasks related to movement of objects in the facility;
an allocation engine executable on a computing device equipped with a processor, the allocation engine when executed:
retrieving, from the one or more databases, a plurality of tasks for moving objects during a predefined time period, each task identifying at least a start location and an end location for moving an object and a temperature zone of the object;
assigning a first set of tasks for moving a first set of objects to the plurality of individuals based on a first set of predefined parameters, the first set of predefined parameters including at least one temperature zone and a time spent by an associated individual in the at least one temperature zone while moving each object between the start location and the end location;
receiving location information from the sensors indicating a location of each associated individual during a performance of the first set of tasks, the location information used to determine the amount of time spent in the at least one temperature zone by an associated individual;
assigning to the plurality of individuals, following completion of the first set of tasks, a second set of tasks from the retrieved plurality of tasks, the second set of tasks for moving a second set of objects based on a second set of predefined parameters, the second set of predefined parameters including at least a total time spent by each of the plurality of individuals in the at least one temperature zone while completing the first set of tasks, and at least one temperature zone and a time spent by each of the plurality of individuals in the at least one temperature zone while moving each object in the second set of objects between the start location and the end location of each object.

17. The system of claim 16, wherein the allocation engine when executed further:
receives location information from the sensors indicating a location of each associated individual during a performance of the second set of tasks, the location information used to determine the amount of time spent in a temperature zone by an associated individual; and
assigns a third set of tasks for moving a third set of objects to the plurality of individuals based on a third set of predefined parameters, the third set of predefined parameters including at least a total time spent by an associated individual in the at least one temperature zone while completing the first set and the second set of tasks, and a temperature and a time exposed to the temperature while moving each object in the third set of objects between the start location and the end location of each object.

18. The system of claim 16, wherein at least one of the first and second set of predefined parameters further include one or more of the following: travel time while performing a task, time since a previous task.

19. The system of claim 16, wherein the allocation engine when executed further:
receives and stores in the one or more databases histories for the plurality of individuals, the histories including at least time spent by each individual of the plurality of individuals in each temperature zone of the at least one temperature zone,
wherein the histories are used in determining at least one of the first and second sets of predefined parameters.

20. The system of claim 16, further comprising:
a machine learning module that when executed by the computing device tests at least one predefined parameter in the first and second sets of predefined parameters to identify one or more optimal parameters for one or more tasks, wherein one or more optimal parameters are used to assign tasks.
